(19) United States
(12) Patent Application Publication
(10) Pub. No.: US 2010/0107844 A1
(43) Pub. Date: May 6, 2010

(54) Automated Hole Punch

(75) Inventors: David Halden, Hertfordshire (GB); Paul Crane, Hertfordshire (GB); Jeffrey W. Ryan, Knebworth (GB); Richard Hubbard, Bedfordshire (GB)

Correspondence Address: Hoffmann & Baron, LLP, 6900 Jericho Turnpike, Syosset, NY, 11791, US

(73) Assignee: Xerox Corporation, Norwalk, CT (US)

(21) Appl. No.: 12/265,525

(22) Filed: Nov. 5, 2008

(51) Int. Cl. B26D 5/16; B26D 1/12

(52) U.S. Cl. 83/628; 83/670

(57) ABSTRACT

An automated hole punch including a die plate having a surface including a plurality of spaced apertures extending there through. A plurality of punches, one of the plurality of punches cooperating with each of the apertures. A raised profile extends outwardly from the surface of the die plate and above one or more of the plurality of apertures. A drive mechanism operatively connected to the plurality of punches for moving the plurality of punches toward the plurality of apertures.

### BACKGROUND

1. Technical Field

The present disclosure relates to document handling in which sheets are prepared by operation of a hole punch.

2. Brief Discussion of Related Art

After media, such as sheets of paper, is printed in a printer, the sheets may be further processed in a finisher section of the machine. The word “printer” as used herein encompasses any apparatus, such as a digital copier, bookmaking machine, facsimile machine, multifunction machine, etc. which performs a print outputting function for any purpose. A common process performed by the finisher on documents and other printed matter is the punching of holes to allow sheets to be bound in a standard ring binder. Such binders are inherently flexible since they allow rearrangement of the order of sheets and allow insertions and deletions at will.

The process of forming the holes is performed by a hole punching unit. Hole punches typically include a die having apertures therein and opposed reciprocating punches which create the holes in the media. Media traveling through the finisher passes over the apertures whether it is to be punched or not. These openings create a potential for snagging the paper as it passes through the hole punch unit. Depending on the orientation of the media, a corner thereof may pass over the openings in the die and may become snagged in the openings, leading to a jam. Jams interrupt the processing and require a user to clear the jam before processing can continue.

Accordingly, it would be desirable to provide a hole punching unit which permits the smooth flow of media over the openings in the hole punch unit in order to avoid processing interruptions.

### SUMMARY

According to aspects illustrated herein, there is provided an automated hole punch including a die plate having a surface including a plurality of spaced apertures extending there through. A plurality of punches, one of the plurality of punches cooperating with each of the apertures. A raised profile extends outwardly from the surface of the die plate and above one or more of the plurality of apertures. A drive mechanism operatively connected to the plurality of punches for moving the plurality of punches toward the plurality of apertures.

According to other aspects illustrated herein, there is provided an automated hole punch including a die plate having a surface and a plurality of spaced apertures extending through the surface. A plurality of punches is disposed above the die plate with one of the plurality of punches cooperating with each of the apertures and being insertable therein. A plurality of tapered raised profiles extends upwardly from the surface of the die plate. Each of the plurality of profiles corresponds to one of the plurality of apertures. A drive mechanism is operatively connected to the plurality of punches for moving the plurality of punches toward and into the plurality of apertures.

According to still other aspects illustrated herein, there is provided a method of punching holes in a sheet including:

providing a hole punch device, the hole punch device including a die plate including a surface having a plurality of apertures formed therein, a punch disposed adjacent each of the apertures and movable with respect thereto;

offsetting the sheet above the surface as it passes over the apertures;

moving the punches toward the apertures and forming holes in the sheet; and

transporting the sheet out of the hole punch device.

### BRIEF DESCRIPTION OF THE DRAWINGS

FIG. 1 is a simplified partial elevational view of a finisher module including a hole punch device.

FIG. 2 is a perspective view of a die plate used in the hole punch device.

FIG. 3 is an elevational front view of the hole punch device.

FIG. 4 is a top plan view of an alternative embodiment of a die plate.

FIG. 5 is a partial perspective view of a further alternative embodiment of the die plate.

FIG. 6 is a partial perspective view of yet another alternative embodiment of a die plate.

FIG. 7 is a perspective view of a still a further alternative embodiment of a die plate.

### DETAILED DESCRIPTION

Exemplary embodiments include an automated hole punch having a die plate including apertures there through and a plurality of punches cooperating with the apertures to form the holes. The hole punch can include raised profiles extending from and above the die plate surface.

As used herein, “hole punch” refers to a device for forming holes in media such as sheets of paper.

As used herein, “die plate” refers to a tool used to cut, shape or form material.

As used herein, “punch” refers to a tool for forming a structure such as a hole in material.

As used herein “raised profile” refers to a structure having a portion offset from a surface.

As used herein “drive mechanism” refers to a device for causing motion of another device.

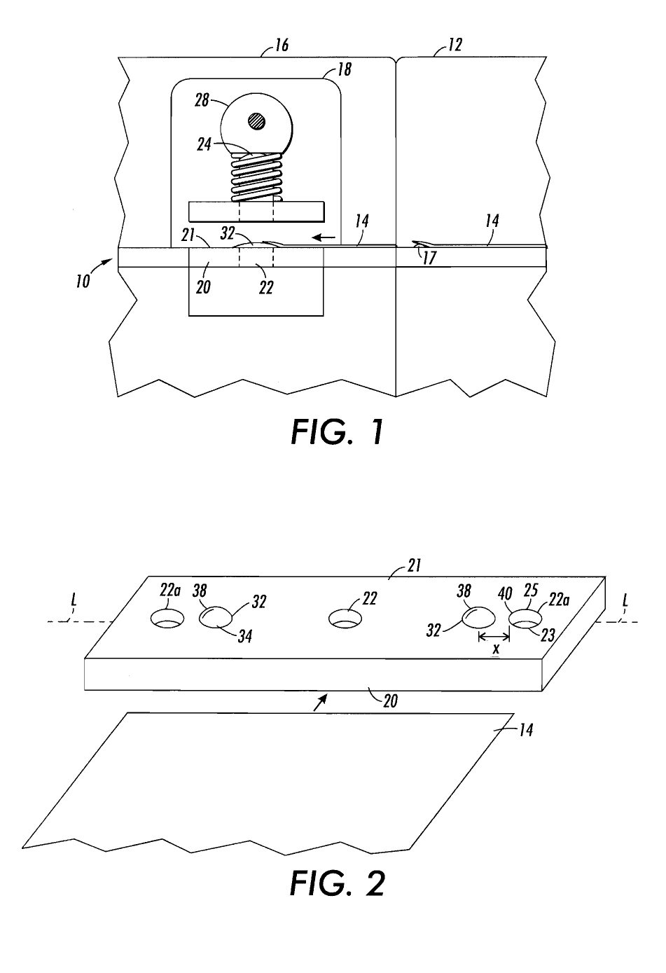

With reference to FIG. 1, a document processing machine 10 such as a copier or printer includes an image processing module 12 where media 14, such as paper sheets, are printed. The machine 10 further includes a finisher module 16 including a hole punch device 18. Printed media 14 is transported from the image processing module 12 to the finisher module 16 by way of transport wheels 17 in a manner known in the art.

With reference to FIGS. 1 and 2, the hole punch device 18 may be disposed adjacent to the entry of the finisher module 16. However, the hole punch device 18 may be located at other locations along the path of the media in the finisher module 16 as desired. The hole punch device 18 may include a die plate 20 which includes a surface 21 over which the media 14 travels. The direction of media travel is indicated by an arrow shown in FIG. 2. Surface 21 supports the media 14 when holes are being punched in the media. Formed in, and extending through, the die plate surface 21 is a plurality of apertures 22 spaced along a longitudinal axis, L, of the die plate 20. The number and location of the apertures 22 may correspond to standard hole patterns for paper used, for example, in binders. Two, three, and four hole punch patterns are commonly used; however, the number and spacing of the apertures may be formed as desired. The apertures 22 include a leading edge 23 and a trailing edge 25 with the media 14 first passing over the leading edge and then the trailing edge as it moves over the die plate 20.

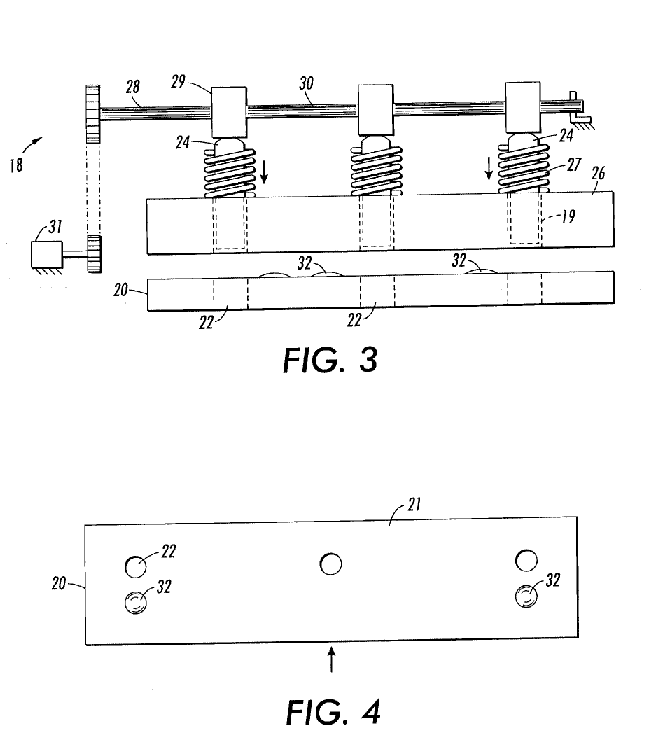

Referring to FIG. 3, the hole punch device 18 may further include a plurality of punches 24 with one supported above each of the apertures 22. Punches 24 may be moveably supported in a frame 26. Frame 26 may include chambers 19 formed therein for receiving the punches 24. Each punch 24 is urged toward a retracted position by a biasing device 27 which may include a coil spring. A drive mechanism 28 moves the punches 24 to an extended position wherein each punch enters its corresponding aperture 22. The drive mechanism 28 may include a series of spaced cams 29 mounted to a cam shaft 30. Cam shaft 30 may be operatively connected to a motor 31. Rotation of the cams 29 results in the punches 24 moving into the apertures 22 and punching the hole in the media 14.

With further reference to FIGS. 1 and 2, die plate 20 may include raised profile 32 disposed adjacent to die apertures 22 and extending outwardly from the surface 21. When the surface 21 lies in a generally horizontal plane, the outward extension of the raised profile 32 is generally upward in a vertical direction. At least a portion of the profile 32 may be disposed upstream of the aperture trailing edge 25. It is the engagement of a corner or edge of a sheet with the aperture trailing edge that typically leads to snagging. When the media 14 approaches an aperture 22, it engages the raised profile 32 and is vertically displaced from the surface 21 as shown in FIG. 1. Accordingly, the leading edge of the media 14 is lifted above the die apertures 22 as it passes by them. This prevents the edges or corners of the media from becoming snagged by die apertures 22, and particularly by the aperture trailing edge 25, and causing a jam.

Raised profile 32 may include a plurality of discrete profiles such that the profiles may be placed adjacent all the die apertures, as shown in FIG. 3, or may be placed adjacent only the die apertures which are most likely to cause snagging. For example, the snagging of the media 14 is especially problematic in a die plate configured for a three-hole punch along the long side of 8.5×11 media. When the 8.5×11 media 14 is fed through the hole punch device 18 short side first, the corners of the media tend to pass over the outer die apertures 22a in a three-hole punch die plate arrangement. To prevent the corners from snagging in these two outer apertures 22a, a raised profile 32 may be positioned adjacent to them as shown in FIG. 2.

The discrete raised profiles 32 may be disposed on the die plate surface 21 adjacent the apertures 22. The apertures 22 may be aligned along longitudinal axis L of the die plate, and the raised profiles 32 are spaced from the apertures 22 along the longitudinal axis L (FIG. 2). The raised profiles 32 are positioned such that the media 14 travels over them. The raised profiles 32 associated with the outer die apertures 22a may, for example, be positioned inward of these die apertures 22a. As a media 14 passes over the apertures, it engages the profiles 32 and starts to lift. Therefore, the edge of the media 14 is above the aperture and will not become ensnared by it. Alternatively, the profile 32 may be located upstream of the apertures 22 as shown in FIG. 4. The media is lifted up and way from surface 21 before reaching the apertures 22.

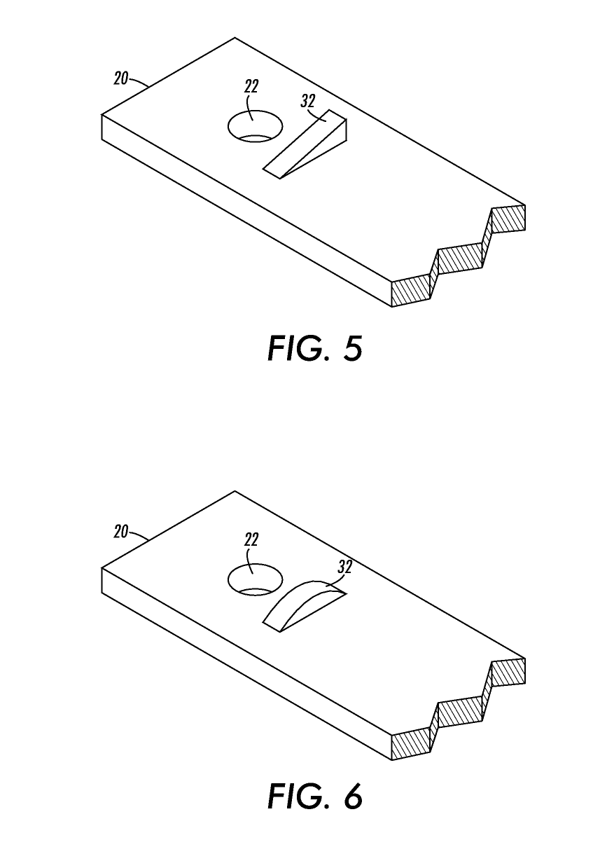

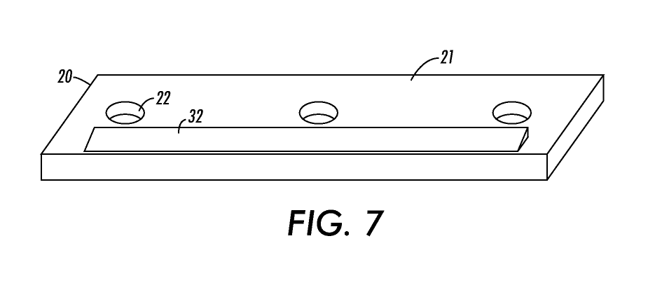

The raised profile 32 may be configured in a variety of shapes including a dome-shaped protrusion as shown, for example, in FIGS. 2 and 3. Alternatively, raised profile 32 may be formed in a variety of shapes, such as, a tapered rail (FIG. 5), ramp (FIG. 7), or convex semicircular structure (FIG. 6). In a further alternative embodiment, raised profile 32 may be a unitary structure extending between at least two of the holes, as shown in FIG. 7.

With reference to FIGS. 2 and 3, a smooth transition is formed between the die surface 21 and the raised profile 32. The leading wall 34 of the raised profile may be tapered upwardly from the die surface 21 to the raised profile top 38 to permit the corner or edge of the media 14 to slip over the raised profile without snagging.

The raised profiles 32 may have a height relative to the surface 21 of about 1 mm. However, the height may, for example, be in the range of about 0.5 mm to 5 mm. Additionally, the center 38 of the raised profile may be located a distance X (FIG. 2) of about 10 mm from the side edge 40 of the apertures 22. Distance X could be in the range of about 1 to 25 mm. The profile 32 at its base may be a diameter of about 8 mm. These dimensions are meant to be for exemplary purposes and are not intended to be limiting.

The raised profiles 32 may be integrally formed with the die plate 20, for example, by punching, pressing, or stamping the die plate. Alternatively, the raised profiles 32 may be formed separately from the die plate 20 and operably coupled thereto by any known fastening means.

In operation, media 14 is acted upon by the image processing module 12 to create the image. The processed media 14 then exits the image processing module 12 and enters the finisher module 16. The media 14 is then transported to the hole punch device 18. The media 14 moves over the die plate 20 and the leading edge of the media 14 encounters the raised profile 32. The media 14 is then lifted above the die plate surface 21 and the apertures 22 formed therein. When the media reaches the appropriate position, if holes are to be punched, the drive mechanism 28 is activated and the punches 24 are driven toward the apertures 22 by action of the cams 29. Punched holes are thus formed in the media. If holes are not to be punched in the media, the drive mechanism may not be activated. The media may be transported out by transport rollers and the next sheet of media may be moved into place for punching. This process continues for the predetermined number of sheets. Media that is not to be hole punched may pass through the hole punch device 18 and over the die plate 20. This media also engages the raised profiles 32 and is offset above the apertures to eliminate snagging and jams.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. An automated hole punch comprising:
a die plate including a surface having a plurality of spaced apertures extending there through;
a plurality of punches, one of the plurality of punches cooperating with each of the apertures;
a raised profile extending outwardly from the surface of the die plate and above one or more of the plurality of apertures; and
a drive mechanism operatively connected to the plurality of punches for moving the plurality of punches toward the plurality of apertures.

2. The hole punch as defined in claim 1, wherein the raised profile includes a plurality of discrete members.

3. The hole punch as defined in claim 2, wherein each one of the plurality of discrete raised profile members is disposed adjacent to each of the plurality of apertures.

4. The hole punch as defined in claim 2, wherein the apertures are aligned along a longitudinal axis of the die plate, and the raised profile is spaced from the apertures along the longitudinal axis.

5. The hole punch as defined in claim 1, wherein the raised profile is convex-shaped.

6. The hole punch as defined in claim 5, wherein the raised profile includes a plurality of dome shaped members.

7. The hole punch as defined in claim 5, wherein the raised profile has a tapered surface extending upwardly from the surface of the die plate.

8. The hole punch as defined in claim 1, wherein the plurality of apertures include a leading edge and a trailing edge defined by direction of travel of media relative to the apertures, and the raised profile is disposed before the trailing edge of the plurality of apertures.

9. The hole punch as defined in claim 1, wherein the plurality of apertures includes at least two least 2 apertures.

10. The hole punch as defined in claim 1, wherein the plurality of apertures includes at least two least 3 apertures.

11. The hole punch as defined in claim 1, wherein the raised profile extends from the die plate surface for a distance of about 0.5 mm to 5 mm.

12. An automated hole punch comprising:
a die plate including a surface and a plurality of spaced apertures extending through the surface;
a plurality of punches disposed above the die plate, one of the plurality of punches cooperating with each of the apertures and being insertable therein;
a plurality of tapered raised profiles extending upwardly from the surface of the die plate, each of the plurality of profiles corresponding to one of the plurality of apertures; and
a drive mechanism operatively connected to the plurality of punches for moving the plurality of punches toward and into the plurality of apertures.

13. The hole punch as defined in claim 12, wherein the plurality of raised profiles includes dome-shaped structures.

14. The hole punch as defined in claim 12, wherein the apertures include a leading edge and a trailing edge, and the raised profile is disposed upstream of the trailing edge.

15. The hole punch as defined in claim 12, wherein the raised profiles are offset from the apertures along a longitudinal axis of the die plate.

16. The hole punch as defined in claim 12, wherein the plurality of raised profiles includes at least two raised profiles and the plurality of spaced apertures includes more than two apertures and each of the at least two raised profiles being disposed adjacent one of the plurality of apertures on the die plate.

17. The hole punch as defined in claim 16, wherein the plurality of raised profiles include convex-shaped members.

18. A method of punching holes in a sheet comprising:
providing a hole punch device, the hole punch device including a die plate including a surface having a plurality of apertures formed therein, a punch disposed adjacent each of the apertures and movable with respect thereto;
offsetting the sheet above the surface as it passes over the apertures;
moving the punches toward the apertures and forming holes in the sheet; and
transporting the sheet out of the hole punch device.

19. The method of claim 18, wherein the die plate includes a raised profile for raising the sheet above the apertures.

20. The method of claim 18, wherein the raised profile includes a plurality of discrete members.
